(19) United States
(12) Patent Application Publication
(10) Pub. No.: US 2017/0032188 A1
(43) Pub. Date: Feb. 2, 2017

(54) PHOTO SHARING METHOD AND DEVICE

(71) Applicant: Xiaomi Inc., Beijing (CN)

(72) Inventors: Tao Zhang, Beijing (CN); Zhijun Chen, Beijing (CN); Fei Long, Beijing (CN)

(73) Assignee: Xiaomi Inc., Beijing (CN)

(21) Appl. No.: 15/218,758

(22) Filed: Jul. 25, 2016

(30) Foreign Application Priority Data
Jul. 31, 2015 (CN) 201510462784.4

(51) Int. Cl. G06K 9/00; H04L 12/58; H04L 29/08

(52) U.S. Cl. CPC G06K 9/00677; H04L 67/306; G06K 9/00684; G06K 9/00288; H04L 51/10; H04L 51/32

(57) ABSTRACT

A method and system for sharing event photos are disclosed. In one embodiment, a photo sharing method includes receiving by a cloud server an event photo sharing request sent by a terminal of an initiator of the request, wherein the event photo sharing request comprises an event marker and account identification information of an cloud account of the initiator in the cloud server, acquiring by the cloud server, from a cloud album corresponding to the cloud account of the initiator, a first event photo set based on the event marker, acquiring by the cloud server, according to at least one contact contained in a contact list in the cloud account of the initiator, at least one second event photo set each from a cloud album of a corresponding one of the at least one contact of the initiator, wherein each photo in the at least one second event photo set is marked with the event marker, and sending a combined event photo set comprising the first event photo set and the at least one second event photo set to the initiator and each contact of the initiator corresponding to each of the at least one second event photo set.

### CROSS-REFERENCE TO RELATED APPLICATIONS

This application is based on and claims priority to Chinese Patent Application No. 201510462784.4, filed on Jul. 31, 2015, the entire contents of which are incorporated herein by reference.

### TECHNICAL FIELD

The present disclosure generally relates to the field of communications technologies, and more particularly, to a photo sharing method and device.

### BACKGROUND

Smart mobile terminals of today can take high quality photos and have largely replaced dedicated cameras as a quick way to record snapshots of people's daily lives. In group activities such as parties and other social gatherings, each participant may take some photos, and may share these photos with other participants. The participants may achieve photo sharing by manually sending photos to each other via, e.g., social media platforms such as WeChat. For example, A, B, C and D may have participated in a party and have each taken some party photos. To share the photos, A may manually send photos taken by her to B, C and D using WeChat™, Twitter, short messaging or the like. In a similar way, B may send his photos to A, C and D; C may send her photos to A, B and D; and D may send his photos to A, B and C.

### SUMMARY

The present disclosure provides a photo sharing method and device. This summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a photo sharing method is disclosed. The method includes receiving by a cloud server an event photo sharing request sent by a terminal of an initiator of the request, wherein the event photo sharing request comprises an event marker and account identification information of an cloud account of the initiator in the cloud server; acquiring by the cloud server, from a cloud album corresponding to the cloud account of the initiator, a first event photo set based on the event marker; acquiring by the cloud server, according to at least one contact contained in a contact list in the cloud account of the initiator, at least one second event photo set each from a cloud album of a corresponding one of the at least one contact of the initiator, wherein each photo in the at least one second event photo set is marked with the event marker; and sending a combined event photo set comprising the first event photo set and the at least one second event photo set to the initiator and each contact of the initiator corresponding to each of the at least one second event photo set.

In another embodiment, a photo sharing system is disclosed. The photo sharing system includes a processor; and a memory configured to store instructions executable by the processor, wherein the processor is configured to cause the photo sharing system to receive an event photo sharing request sent by a terminal of an initiator of the request, wherein the event photo sharing request comprises an event marker and account identification information of an cloud account of the initiator in the system, acquire, from a cloud album corresponding to the cloud account of the initiator, a first event photo set based on the event marker, acquire, according to at least one contact contained in a contact list in the cloud account of the initiator, at least one second event photo set each from a cloud album of a corresponding one of the at least one contact of the initiator, wherein each photo in the at least one second event photo set is marked with the event marker, and end a combined event photo set comprising the first event phot set and the at least one second event photo set to the initiator and each contact of the initiator corresponding to each of the at least one second event photo set.

In yet another embodiment, a non-transitory computer-readable storage medium is disclosed. The storage medium has stored therein instructions that, when executed by a processor of a server, causes the server to receive an event photo sharing request sent by a terminal of an initiator of the request, wherein the event photo sharing request comprises an event marker and account identification information of an cloud account of the initiator in the server; acquire, from a cloud album corresponding to the cloud account of the initiator, a first event photo set based on the event marker; acquire, according to at least one contact contained in a contact list in the cloud account of the initiator, at least one second event photo set each from a cloud album of a corresponding one of the at least one contact of the initiator, wherein each photo in the at least one second event photo set is marked with the event marker; and send a combined event photo set comprising the first event photo set and the at least one second event photo set to the initiator and each contact of the initiator corresponding to each of the at least one second event photo set.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 illustrates an application context for the embodiments of the present disclosure.

FIG. 2 illustrates a flowchart of one embodiment of a photo sharing method;

FIG. 3 illustrates a flowchart of another embodiment of a photo sharing method;

FIG. 4 illustrates a flowchart of another embodiment of a photo sharing method;

FIG. 5 illustrates a flowchart of another embodiment of a photo sharing method;

FIG. 6 illustrates a block diagram of one photo sharing device according to an exemplary embodiment;

FIG. 7 illustrates a block diagram of another photo sharing device according to an exemplary embodiment;

FIG. 8 illustrates a block diagram of another photo sharing device according to an exemplary embodiment;

FIG. 9 illustrates a block diagram of another photo sharing device according to an exemplary embodiment;

FIG. 10 illustrates a block diagram of yet another photo sharing device according to an exemplary embodiment; and

FIG. 11 illustrates a block diagram of another photo sharing device according to an exemplary embodiment.

Specific embodiments of the present disclosure are shown by the above drawings, and more detailed description will be made hereinafter. These drawings and text description are not for limiting the scope of conceiving the present disclosure in any way, but for illustrating the concept of the present disclosure for those skilled in the art by referring to specific embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

Terms used in the disclosure are only for purpose of describing particular embodiments, and are not intended to be limiting. The terms “a”, “said” and “the” used in singular form in the disclosure and appended claims are intended to include a plural form, unless the context explicitly indicates otherwise. It should be understood that the term “and/or” used in the description means and includes any or all combinations of one or more associated and listed terms.

It should be understood that, although the disclosure may use terms such as “first”, “second” and “third” to describe various information, the information should not be limited herein. These terms are only used to distinguish information of the same type from each other. For example, first information may also be referred to as second information, and the second information may also be referred to as the first information, without departing from the scope of the disclosure. Based on context, the word “if” used herein may be interpreted as “when”, or “while”, or “in response to a determination”.

The term “smart terminal”, “terminal device”, “terminal”, “mobile phone”, “smart phone”, “terminal device”, “mobile terminal”, “mobile device” and the like are used interchangeably in this disclosure. An “application” or “app” refers to a software program that may be installed on a mobile terminal. An application may appear as an icon on the displayed interface of an operating system of the mobile terminal. An application may be run by a user when activated by the user via appropriate input means (e.g., double click through a mouth-cursor input means, or click of the app icon via a touch screen). An application, when being run on the mobile terminal, may provide a user interface for accepting user instructions and may communicate with an application server via any form of communication channels to obtain services desired by the user.

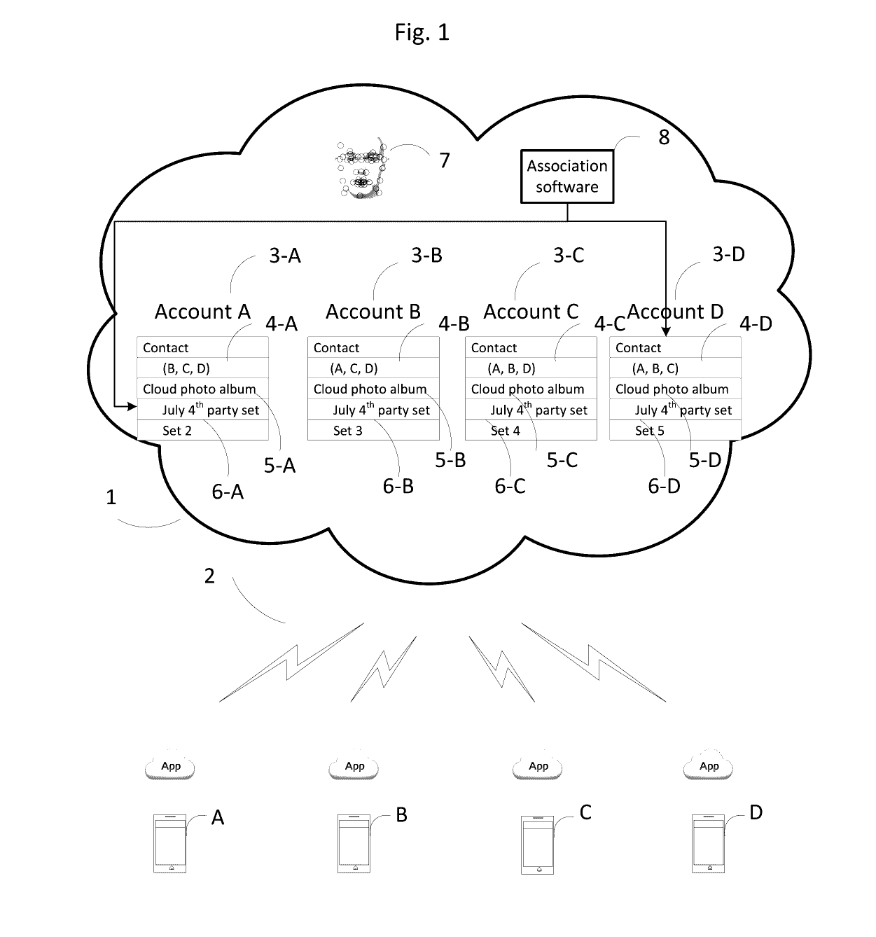

By way of introduction to the method and device embodiments according to the present disclosure, FIG. 1 illustrates a typical context for users of a cloud service to share group photos via mobile terminals and the cloud service. Mobile terminals A, B, C, and D for four different users may be each installed with an application (referred to as “cloud app” hereinafter). Each terminal may be in communication via communication network 2 with the cloud service 1. Each user may have established a service account with the cloud service 1 supported by a plurality of central or distributed cloud servers, as illustrated by 3-A, 3-B, 3-C, and 3-D. The cloud app installed in each mobile terminal contains the necessary credential of respective user for accessing the respective cloud account. The cloud service 1 may provide photo storage for a user and may further help manage contact information for a user. Contacts listed in a user's account may or may not also be users of the cloud service 1. Thus in each of the user accounts 3-A to 3-D, storage space may be allocated for photos and contacts, as shown by 4-A, 4-B, 4-C, 4-D, 5-A, 5-B, 5-C, and 5-D. Recorded information of a contact may include but is not limited to name, phone number, email address, account ID within this same cloud service (if the contact is also a user of the same cloud service), other social media account IDs, and a profile picture (or photo sticker). Those of ordinary skill in the art understand that in practice and alternatively, storage spaces for data of user accounts, photos in particular, may be centrally managed and thus all photos from users may be stored together rather than allocated separately and each user account may only need to maintain a collection of pointers to the actual storage location of the photos. The cloud service 1 may be, for example, a synchronization service for user data (including contacts and photos) on mobile terminals.

Each collection of photos for a particular user is herein referred to as a cloud album. User photos stored in the cloud may be associated with labels or markers indicating the context information for each individual photo, such as time, date, and location. Thus, photos with like time, date and location in the cloud photo album of a user may be recognizable as a set of photos taken from one event or setting. Sets of such photos are illustrated by 6-A, 6-B, 6-C, and 6-D. The cloud service may further include an image analysis tool 7 with face-recognition capability (herein referred to as “face-recognition tool”) that may be used for analyzing photos in various embodiments disclosed below. For example, the face recognition tool may be used to find faces belonging to a same person across albums (of different users). Thus, photo sets from different users taken from like time and location and further with common faces may be positively identified as related sets associated with the same event or setting, such as the sets within 6-A, 6-B, 6-C, and 6-D identified as “July 4th party set” in FIG. 1. In the particular example of FIG. 1, users A-D all participated in the same July 4th party, took photos and stored the photos in their respective cloud albums.

The contact information 4A, 4B, 4C and 4D of a contact of the respective user again may include but is not limited to name, phone number, email address, account ID within this same cloud service, other social media account IDs, and profile picture such as a portrait of the contact. The cloud service may use the contact information to automatically share photos by for example, copying the photos to be shared into the photo album of the user to be shared within the same cloud service 1 (if the contact is also a user of and thus has an account with the could service 1). Alternatively, the photos to be shared may be sent to the phone number, email address, or other social media accounts of the user to be shared with. In the example illustrated in FIG. 1, users A, B, C, and D of the cloud service 1 are friends of each other and each appears in the contact list of the others. Those of ordinary skill in the art understand that when various user albums are stored together and each user account only maintain its photo albums as a collection of pointers, the pointers to the photos rather the photos themselves need to be copied between user accounts for sharing between the users within the same cloud service 1.

The cloud service may further contain software component 8, herein referred to as “association software”, that is capable of associating images in user photo albums with contacts across user accounts via the face-recognition tool. Specifically, a face in the profile picture of the contact information for contact (which may also be a user of the cloud service 1) may be matched with a face in a photo image in an album. The user corresponding to that contact information may thus be recognized automatically as one of the targets for photo sharing. In the example FIG. 1, the association software may identify that one of the contact of user D have a matching face with a person appeared in at least one of the photos in the July 4th party set of user A.

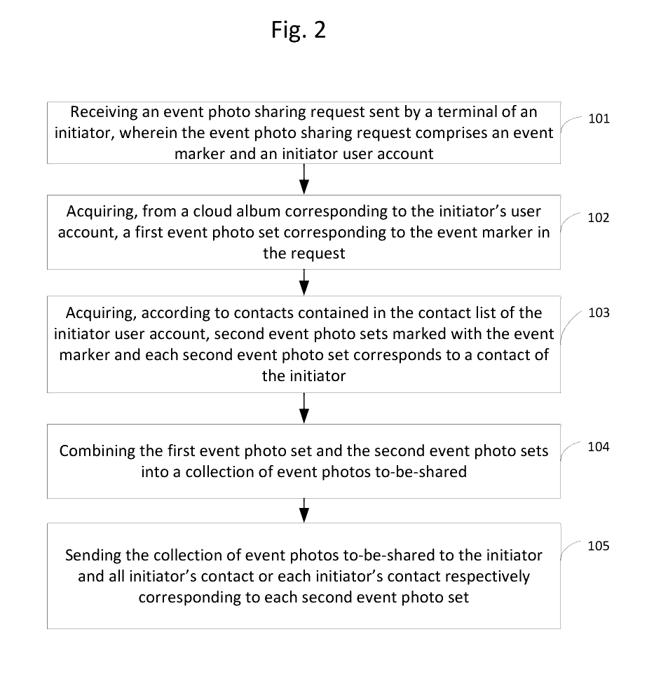

FIG. 2 illustrates a flowchart of a photo sharing method according to an exemplary embodiment of present disclosure. The method may be performed by the cloud server or a device integrated with the cloud server. In Step 101, the cloud server receives a photo sharing request sent by a user via the cloud app in a corresponding mobile terminal for photos taken at a particular event. This user is herein referred to as the initiator of the photo sharing service. The request for photo sharing may include an identifier or marker (the two terms are used interchangeably) for the event and the initiator's user account information with the cloud service. In the context shown in FIG. 1, the event may be the July 4th party. Users A, B, C and D may be at the party and have each taken some photos. These photos may be identified or marked by the date/time (July 4th) and location. These photos may be referred to as July 4th party photos. Moreover, any of these photos may be marked with at least one event marker. The event marker may include information such as time, location, event name (or event scene) or the like. The time information may be automatically determined according to a system clock of the user terminal when the photo was taken. The location may be determined according to GPS location information of the user terminal when the photo was taken. The event scene may be a specific name of the event or the name of the place input by the user (when giving a name or group name to photos, for example) or automatically by the terminal by combining the location information with a map having correspondence between locations and names of facilities. Examples of event marker utilizing event scene may be certain park or a certain playground. For different terminals taking photos at the same event, the marker information may be identical. For example, the photos taken by A, B, C and D at the same July 4th party in a park may have identical marker containing similar time, similar location, or the name of the same park.

Photos may alternatively be marked by the cloud service. Specifically, the cloud service may analyze and tag or mark each photo according to the time, location, and the facility information when the photo was taken based on image tagging algorithms. The cloud service may further refine the tagging or marker by analyzing a group of photos and finding the correlation between the photos and tag the photos in groups. The users may access the tags or markers under their cloud. When the user decides to and makes request to share a single or a group of photos, the markers for these photos may be directly identified by the cloud service receiving the request.

All these photos may be also stored in cloud accounts for A, B, C, and D. Specifically, each user may upload and store data contents (such as a contact list, photos, and the like) in the user terminal into the cloud server under the corresponding cloud account for each user. The event marker information discussed above and as part of the photos will be stored in the cloud accounts as well. The markers may be stored by the cloud services together with the photo (as, for example, part of header information for the photo) or separate from the photo itself. For this purpose, each user may register and obtain a user account in the cloud server prior to using the service, and correspondingly the cloud server may allocate certain memory space for each registered user to store data contents related to the user including the photos and associated markers.

For an exemplary application of step 101, the user of terminal A may be the initiator of the request to share July 4th party photos and may send the request to the cloud server. Specifically, the cloud app installed in terminal A may provide functions and an interface for sending request for sharing event photos among participants. The user of terminal A may thus start the cloud app and input the user account (or alternatively, the user account information may be already stored in the cloud app and attached to the request automatically) and determine marker information for the set of photos that the user of terminal A desires to share. For example, the user may select one of the photos in her album and use marker for that photo as the marker information for the set of photos that she desire to share. The cloud app may combine at least the user account and marker information into an event photo sharing request and sends it to the cloud server.

In Step 102 of FIG. 2, a first set of event photos corresponding to the event marker information in the photo sharing request is acquired from the cloud album of the user account for the initiator. In Step 103, a contact list of the initiator is obtained by the cloud server from the initiator's account, and to the extent that a contact of the initiator is also a holder of an account of the same cloud service, the cloud server extracts the cloud account identification for that contact, checks the cloud album of that contact and identifies a second set of event photos from that album. The identification of the second set of event photos is based, again, on the marker information in the photo sharing request and the marker information of the photos found in the album of that contact. The initiator may have multiple contacts that have accounts with the cloud services and have taken photos at the same event. Thus, there may correspondingly be multiple second sets of event photos being identified. This represents a convenient way to identify photos of the same event from co-participants of the event because the co-participants are likely friends of the initiator and thus are likely to be among the contact list of the initiator. Thus, with step 103, photos taken from the same event (i.e., second sets of event photos) by participants of the event other than the initiator may be obtained from the cloud albums corresponding to cloud accounts belonging to contacts of the initiator.

In one implementation of the step 103 above, after the each contact contained in the contact list corresponding to the initiator user account is obtained, cloud account identifying information corresponding to each contact in the contact list may be determined by the cloud server according to a correspondence relation between the each contact user account and each contact information in the contact list of the initiator (such as the name of the contact or the phone number information of the contact). Then, for the album of cloud account of each contact, the cloud server determines whether an event photo set (i.e., one of the second event photo sets) marked with marker information identical to the marker information in the event photo sharing request is present and acquire the photo set (if exist) as one of the second sets of event photos.

In Step 104, the server combines the first set of event photos and all the second sets of event photos in to a combined collection of event photos to-be-shared (also referred to herein as a combined event photos or event photos to-be-shared). In Step 105, the collection of event photos to-be-shared is sent to the initiator and each contact in the contact list of the initiator corresponding to each set of the second sets of event photosrespectively according to contact information of the initiator and contact information of each corresponding contact. Thus, a contact whose album does not contain any identified photo of the same event may not be sent the collection of event photos to-be-shared. That way, it is more probable that the photos are only shared among the likely participants of the event. Alternatively, the cloud may also be configured to send the collection to all contacts of the initiator regardless of whether a contact have any identified event photos in its album (the rationale for this alternative is that all of the initiator's friend may want to see photos related to the initiator).

For example, in the context of FIG. 1, since A, B, C, and D were all participant of the July 4th party, took photos and marked them with a July 4th party marker, and are among contact lists of one another, after step 104, the first event (July 4th party) photo set (denoted by Set 1) corresponding to the initiator A, a second event photo set (denoted by Set 2) corresponding to the contact B, another second event photo set (denoted by Set 3) corresponding to C, and yet another second event photo set (denoted by Set 4) corresponding to the contact D may be combined and sent as a collection and shared by all of A, B, C, and D. The cloud server may alternatively be configured to share the photo collection with contacts of A other than B, C, D even though those contacts were not at the party.

Thus, in the embodiment of FIG. 2, after an event photo sharing request carrying a user account information and an event marker sent by a certain party participant (the initiator) is received by the cloud server, a first event photo set corresponding to the requested event marker is acquired from the cloud album of the initiator's user account. Further, each existing second event photo set corresponding to the requested event marker is acquired from a cloud album of each contact among the contacts contained in a contact list in the cloud account of the initiator. Finally, the collection of event photos to-be-shared including the first event photo set and the second event photo sets is sent to the initiator and each contact of the initiator having at least one identified event photo or all contacts of the initiator.

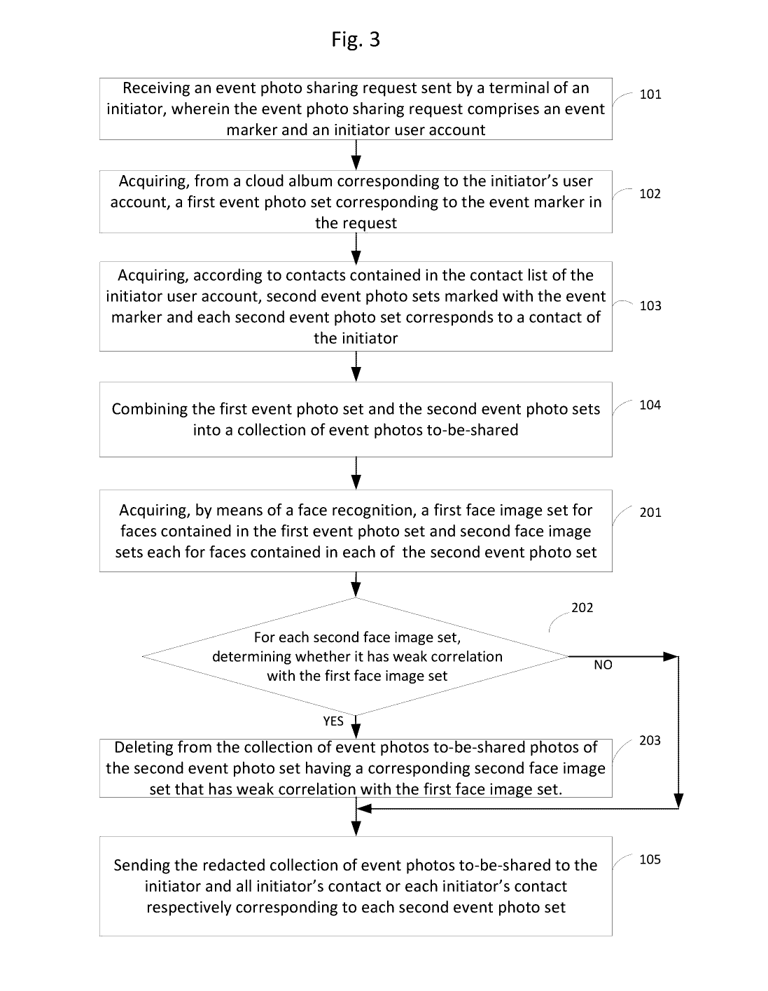

However, in one practical situation, there may be a false identification in the method of FIG. 2 of photos taken by B, C, or D as event photos (having marker identical to that in the request for photo sharing). B, C, or D may not in fact be a participant of the July 4th party. For example, A, B and C may have participated in the party. D, however, may have been at the same place and at the same time for a different party with another group of people. In such situation and following the method embodiment of FIG. 2, unintended photo-sharing may occur between participants of two different parties. This special case may be addressed by the embodiment shown in FIG. 3.

Specifically, FIG. 3 illustrates a flowchart of another embodiment of a photo sharing method. In this embodiment, after the Step 104 of the embodiment as shown in FIG. 2, further steps may be included to exclude the falsely identified event photos above. In Step 201, it is acquired, by means of face recognition based on the face-recognition tool 7 of FIG. 1, a first face image set for recognized faces contained in the first event photo set and second face image sets for recognized faces contained in each of the second event photo sets. In particular, each photo in each event photo set (first set, or each of the second sets) may be analyzed by the face-recognition tool and all faces in each photo set are identified as a set of face images. For example, the first event photo set may contain 5 photos, these 5 photos may together contain 20 faces and thus the first face image set may contain all 20 faces. Each first face image set may contain parameters describing the faces rather than actual face images. In Step 202, it is determined by the cloud server whether a second face image set having weak correlation with the first face image set is present among the second face image sets. The correlation between two face image sets is measured by how close the faces of one set match the faces of the other set. For example, degree of matching between one face in one face image set and one face in the other face image set may be qualified by the face-recognition tool. An overall degree of match between the two face image sets may then be quantified to represent the correlation. Alternatively, only the number of matches that are above a predetermined matching threshold may be used to represent the correlation. The correlation may be considered weak if the correlation is lower than a predefined correlation threshold. If a second face image set is determined to have weak correlation with the first face image set, the server may determine that the corresponding second event photo set is a false identification and thus in Step 203, that particular second event photo set may be deleted from the collection of event photos to-be-shared and the collection of event photos may thus be redacted. Otherwise, the corresponding second event photo set may be kept in the collection of event photos to-be-shared.

In one implementation, determining whether two face image sets are weakly correlated may comprise determining a number of unique identical face images between the two face image sets; determining an occurrence number of identical face images between the two face image sets; and determining that the two face image sets are weakly correlated when the number of unique identical face images is smaller than a preset number threshold and the occurrence number of identical face images is smaller than a preset occurrence number threshold.

For example, assume that the first event photo set (identified from initiator A's album) corresponds to a first face image set A1. A second identified event photo set of one of A's contacts, B, corresponds to a second face image set B1. Another identified second event photo set of another contact of A, i.e., C, correspond to another second face image set C1. And yet another identified second event photo set of yet another contact of A, i.e., D, corresponds to yet another second face image set D1. Supposing the face-recognition tool determines that multiple face images (e.g., six for B1 and seven for C1) identical to some face images in Al are found in B1 and C1, and the number of the unique identical face images (e.g., four between B1 and Al, and five between C1 and A1) is greater than the preset number threshold (e.g., three) and the occurrence number of identical images (six for B1, and seven for C1) is greater than the occurrence number threshold (e.g., five), the server may then determine that B1 and C1 are strongly correlated with Al, indicating that A, B and C are probably co-participants of the same party. Contrarily, if the number of unique identical face images between D1 and A1 (e.g., two) is smaller than the preset number threshold (three) and the occurrence number of identical face images between D1 and A1 (e.g., four) is smaller than the occurrence number threshold (five), the cloud server may determine that D1 is weakly correlated with A1, indicating that D and A probably participated in different parties and the second event photo set corresponding to D's album thus may be removed from the collection of event photos to-be-shared. Afterward, the redacted collection of event photos to-be-shared containing the first event photo set (corresponding to A), and second event photo sets (corresponding to B, and C) may be sent to A, B, and C.

Those of ordinary skill in the art understand that in some implementation, one of the number of unique identical face images and the occurrence number of identical face images between two face image sets, rather than both numbers, is used for determining whether two face image sets are weakly correlated.

Thus, in this embodiment of FIG. 3, based on correlation screening and processing of each face image set corresponding to the each event photo set, those event photo sets with weak correlation with the event photo set of the initiator may be deleted from the collection of event photos to-be-shared, thereby improve the accuracy and reliability of intended photo sharing.

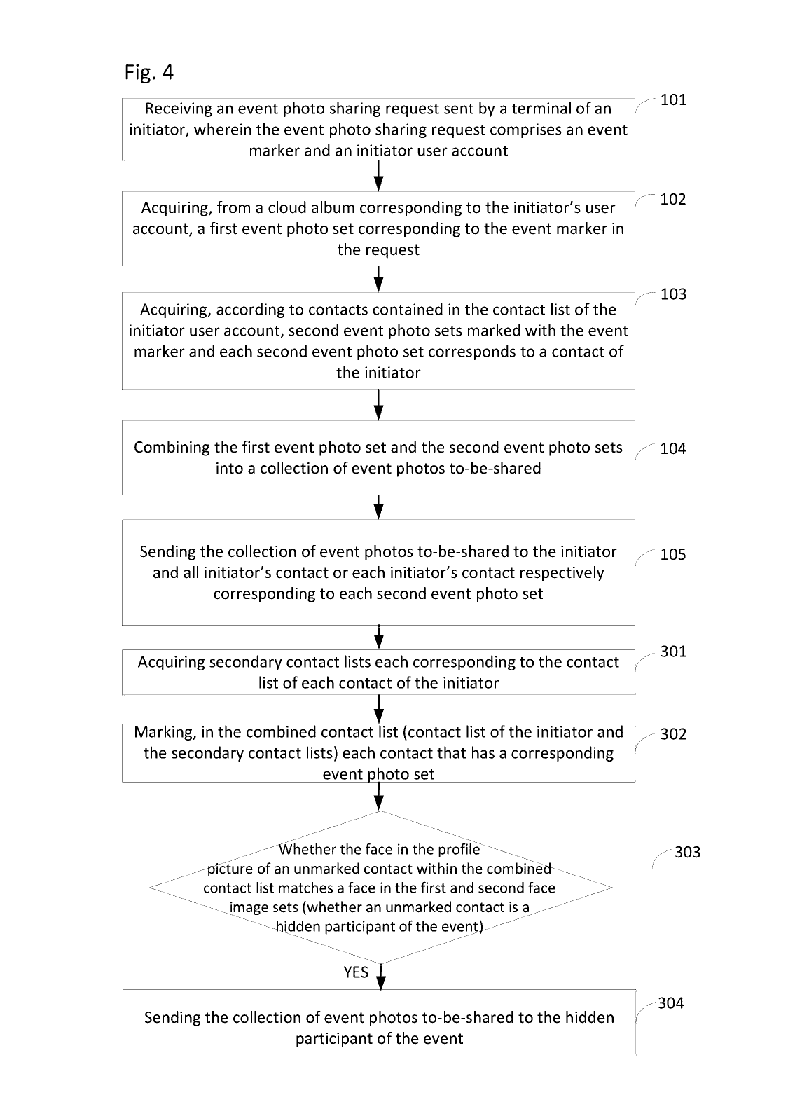

A practical application may present another special case. That is, in some situation, a participant of the event may fail to take any event photo but yet desire to receive the collection of event photos to-be-shared. Following the embodiment in either FIG. 2 or FIG. 3 above, the cloud server may not be able to identify that participant as someone who may receive the shared photos. For example, assume that A, B, C and E participated in the July 4th party above (note that E is not shown in FIG. 1). A is the initiator of the photo sharing request. A, B, and C took event photos during the party but E did not. However, it is appropriate or may be even desired to send the July 4th party shared photos to A, B, C, as well as E because E is a participant and is likely to be interested in seeing the shared photos. Assume also that E is not in the contact list of A. Following the embodiments of FIG. 2, E thus would not receive the shared photo because E is not in A's contact. Even if E is in A's contact, E may still not receive the shared event photos if the cloud server in step of 105 of FIG. 2 only sends the collection of event photos to-be-shared contacts of A who took at least one event photos (or in other words, who has a set of event photos in a corresponding cloud album, simply because E did not taken any photo at the party and thus could not have a set of event photos in its album). The embodiment shown in FIG. 4 addresses this deficiency and allows E to receive shared photos.

Specifically, FIG. 4 illustrates a flowchart of one embodiment for a photo sharing method. This embodiment is based on FIG. 2 but includes further steps that allow for sharing event photos with an event participant who did not take any event photo or is not in the contact list of the initiator (referred to as a hidden participant). This embodiment is based on an assumption that this hidden participant of the event have appeared in at least one of the event photos taken by others and may be in the contact lists of at least one of the contacts of the initiator. These contact lists of the initiator's contact are referred to as secondary contact lists. In Step 301, secondary contact lists each for each contact of the initiator who participated in the event and took photos (and thus has a corresponding second event photo set) is acquired by the server. These initiator's contacts participated in the event and thus may be friends of the hidden participant and may thus have the hidden participant in their contact lists. Each secondary contact list corresponds to one contact of the initiator who took at least one photo at the event.

In Step 302, among the contacts of the initiator's contact list and all secondary contact lists (referred herein as combined contact lists), the contacts that have corresponding event photo sets in their cloud album are identified and marked. The rest of the contacts (unmarked contacts) in the combined contact lists are thus those not at the event or those that were at the event but did not take any photos. For example, assume that the contact list of the initiator A includes B and C, the secondary contact list of contacts of B includes A, C and E, and the secondary contact list of contacts of C includes A, B, and F. So the combined contact lists include A, B, C, E, and F. Assume further that A, B, and C were at the event and took photo, E was at the event and thus appeared in some event photos taken by others but did not take event photo himself, and F was not at the even at all. Among all contacts in the combined contact lists, A, B, and C may be identified and marked in Step 302 because they are the ones who were at the party and took event photos. E is not identified or marked because E did not take any photo. F is not identified or marked either because F is not at the event at all.

Further assume that each foregoing secondary contact list not only includes the name and contact information for listed contacts but also includes a profile photo of each listed contact, such as a photo sticker. Then, if the face in the profile photo of an unmarked contact within the combined contact lists matches at least one face image in the first or second face image sets discussed previously (faces appeared in all event photos), it suggests that this particular unmarked contact is in at least one of the event photos and was thus a participant of the event. Thus, in Step 303, each face image contained in the first and second face image sets is compared with the face extracted by the face-recognition tool from the profile picture of each unmarked contact within the combined contact lists, and the cloud server determine whether there is at least one match (see previous discussions in FIG. 3 for using the face-recognition tool to obtain the first and second face images). A match occurs when the face recognition tool determines that similarity between the face images compared is greater than a predetermined threshold, as discussed previously. A match indicates that the contact in the combine contact lists having a matching profile picture was a hidden participant: he was at the event and should receive the event photos to-be-shared even if he did not take any event photo himself. In Step 304, the collection of event photos to-be-shared may be sent to the hidden participant according to the contact information of the hidden participant specified in the combined contact lists.

In the above example, only contacts E and F are not marked. Thus the face images (of the first and second face image sets) are compared with faces of E and F extracted by the face recognition tool from the profile picture of E and F. The cloud server find that E has a face extracted from its profile picture (in B's contact list) that matches one of the face images extracted from the event photo sets and thus the cloud server determines that E is a hidden participant. The cloud server, however, could not find a match for F (F did not participate in the July 4th party). In this situation, the cloud server determines that the collection of July 4th party photos may be sent to the hidden party participant E among others. The cloud server then acquires E's contact information from B's cloud account (in B's contact list) and sends the collection of photos to-be-shared to E.

Thus, in embodiment of FIG. 4, a hidden event participant may be identified and may be sent the collection of event photos to-be-shared, thus expanding the reach of event photo sharing.

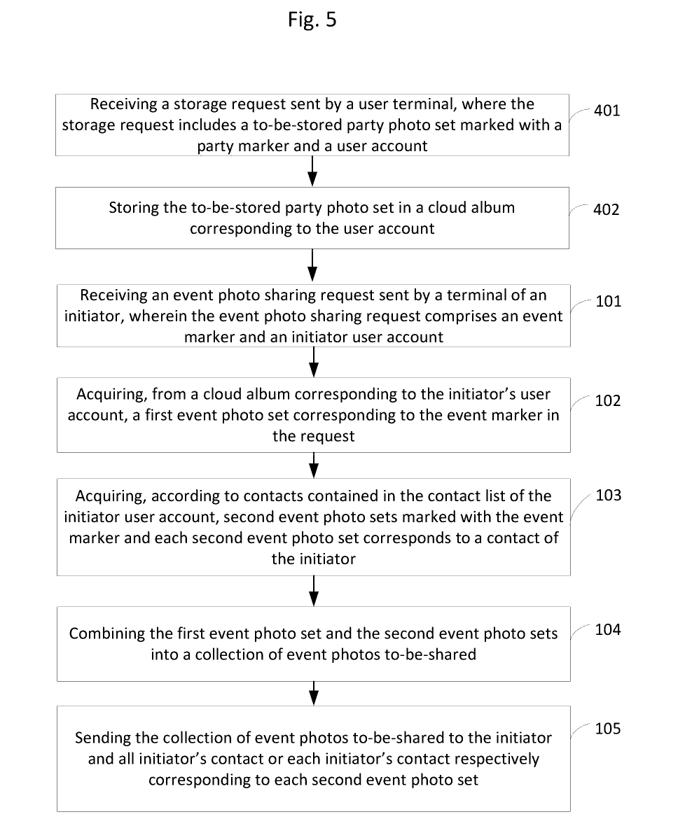

Although FIG. 5 shows the step 301, 302, 303, and 304 after step 105, that ordering is only exemplary and is not intended as limiting the scope of this disclosure. For example, step 301-304 may be performed before, or in parallel with step 105, or may be in parallel with step 104 and 105. Any other orders of the steps are anticipated. The same applies to other figures and embodiments of this disclosure.

FIG. 5 illustrates a flowchart of an embodiment of a method for storing photos by a cloud service and for sharing of event photos. This method is based on FIG. 2 but includes further steps for storing event photos in the cloud service. In Step 401, a storage request sent by a user terminal is received, where the storage request includes a user account information and an event photo set to-be-stored marked with an event marker. In Step 402, the event photo set to-be-stored is stored in the cloud album corresponding to the user account.

In this embodiment, it is assumed that each user registers a user account in the cloud server to enable cloud storage for data contents (such as a contact list, a photo, an audio/video or the like) stored in the terminal.

Specifically, the user who wanted to send an event photo set (i.e., several photos at a party) to a cloud album corresponding to the user account at the cloud server for storage may need to name or mark the event photo set. Specifically, the event photo set may be organized into a folder containing the event photo set and the folder may be named using an event marker. The specific composition of event marker is described in the embodiments above. Alternatively, the markers for the photo may be determined by the cloud service using various tagging and marking algorithms as described above.

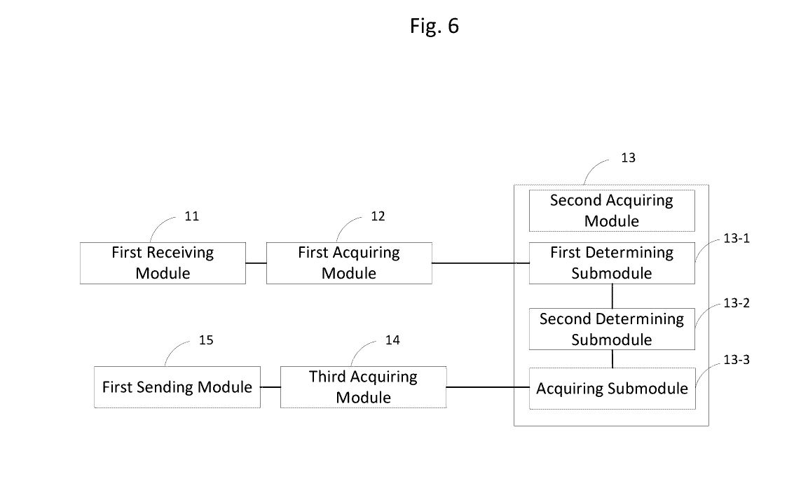

FIG. 6 illustrates a block diagram of a photo sharing device according to an exemplary embodiment. As shown in FIG. 6, the photo sharing device includes: a first receiving module 11, a first acquiring module 12, a second acquiring module 13, a third acquiring module 14 and a first sending module 15. The first receiving module 11 is configured to receive an event photo sharing request sent by a terminal of an initiator, where the event photo sharing request includes an event marker and an initiator user account. The first acquiring module 12 is configured to acquire, from a cloud album corresponding to the initiator user account, a first event photo set corresponding to the event marker. The second acquiring module 13 is configured to acquire, according to each contact contained in a contact list corresponding to the initiator user account, each second event photo set marked with the event marker. The third acquiring module 14 is configured to acquire a collection of event photos to-be-shared including the first event photo set and each second event photo set. The first sending module 15 is configured to send the collection of event photos to-be-shared to the initiator and the each contact having a corresponding second event photo set.

In one implementation of the second acquiring module 13, the second acquiring module 13 may include a first determining submodule 13-1, a second determining submodule 13-2 and an acquiring submodule 13-3. The first determining submodule 13-1 is configured to determine each contact user account corresponding to the each contact contained in the contact list of the initiator. The second determining submodule 13-2 is configured to determine whether a second event photo set marked with the event marker is present in a cloud album corresponding to the user account of each contact of the initiator. The acquiring submodule 13-3 is configured to acquire, if the second event photo set marked with the event marker is present, each second event photo set, and determine each contact corresponding to each second event photo set according to the first contact list.

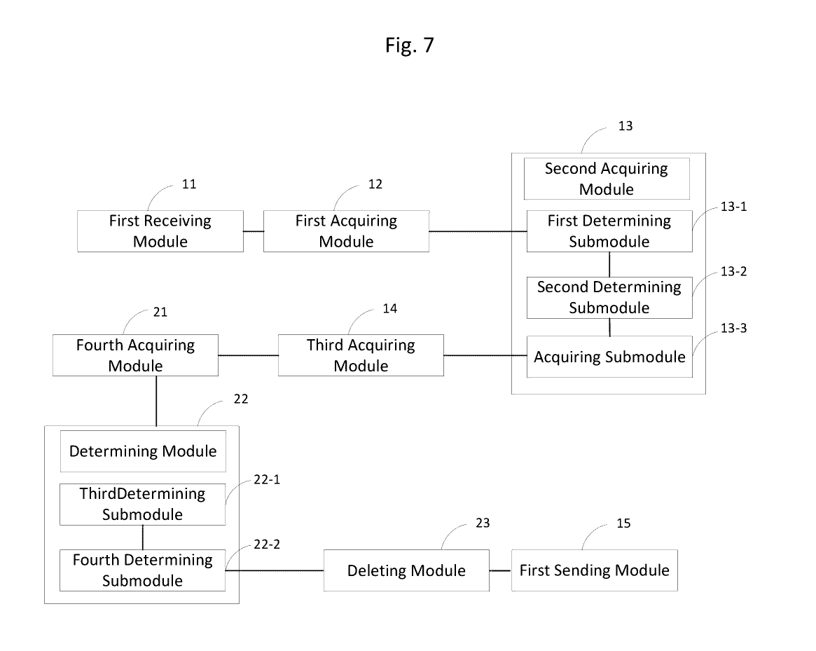

FIG. 7 illustrates a block diagram of another photo sharing device according to an exemplary embodiment. As shown in FIG. 7, on the basis of the embodiment as shown in FIG. 6, the photo sharing device further includes: a fourth acquiring module 21, a determining module 22 and a deleting module 23. The fourth acquiring module 21 is configured to acquire, by means of face recognition, a first face image set contained in the first event photo set in the to-be-shared party photo set and second face image sets each respectively contained in the each second event photo set. The determining module 22 is configured to determine whether a second face image set having weak correlation with the first face image set is present among the second face image sets. The deleting module 23 is configured to delete, from the to-be-shared party photo set, if a second face image set having weak correlation with the first face image set is present, the second party photo set corresponding to the second face image having weak correlation with the first face image set. In one implementation, the determining module 22 may include a third determining submodule 22-1 and a fourth determining submodule 22-2. The third determining submodule 22-1 is configured to determine respectively, for the each second face image set, the number of identical face images between the second face image set and the first face image set. The fourth determining submodule 22-2 is configured to determine that a second face image set is weakly correlated with the first face image set if the number of the identical face images is smaller than a preset number threshold.

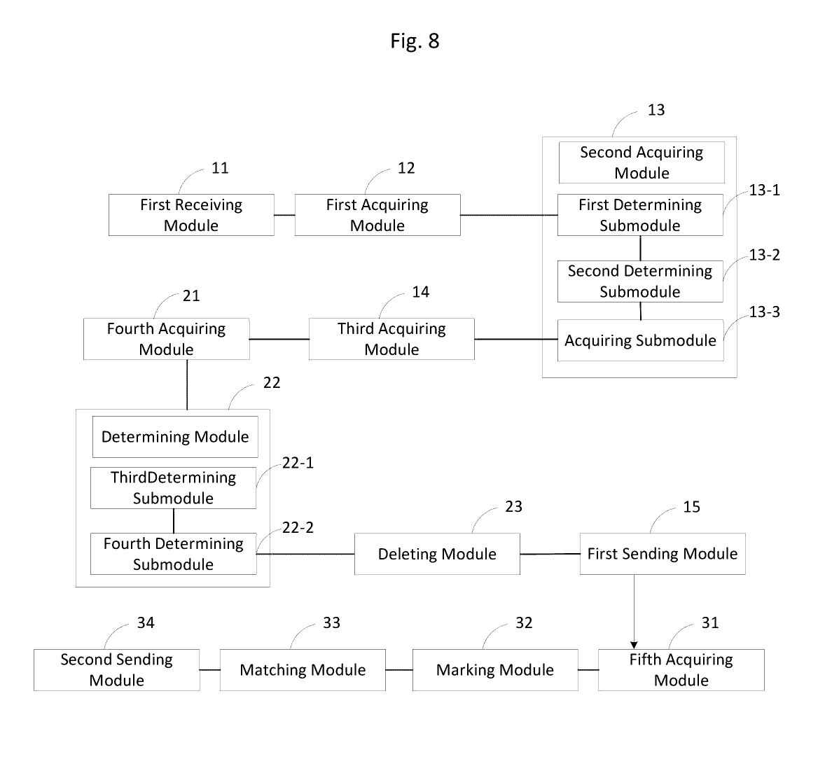

FIG. 8 illustrates a block diagram yet another photo sharing device according to an exemplary embodiment. As shown in FIG. 8, on the basis of the embodiment as shown in FIG. 7, the device further includes a fifth acquiring module 31, a marking module 32, a matching module 33 and a second sending module 34. The fifth acquiring module 31 is configured to respectively acquire each contact list (a secondary contact list) corresponding to the each contact of the initiator. The marking module 32 is configured to mark, in the contact list of the initiator and each secondary contact list (combined contact lists), the initiator and each contact corresponding to ach second event photo set. The matching module 33 is configured to respectively match each face image contained in the first face image set and in the each second face image set with a photo of each contact not marked in the combined contact lists to determine whether a matched face of a non-marked contact is present. The second sending module 34 is configured to send the to-be-shared event photo set to the matched non-marked contact.

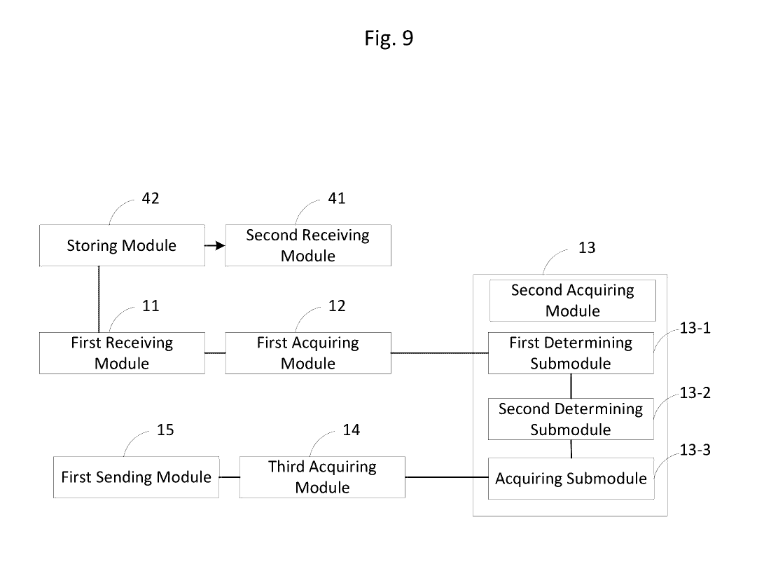

FIG. 9 illustrates a block diagram of another photo sharing device according to an exemplary embodiment. As shown in FIG. 9, on the basis of the foregoing embodiment in FIG. 6, the device further includes a second receiving module 41 and a storing module 42. The second receiving module 41 is configured to receive a storage request sent by a user terminal, where the storage request includes a to-be-stored event photo set marked with a event marker and a user account. The storing module 42 is configured to store the to-be-stored party photo set in a cloud album corresponding to the user account.

With respect to the photo sharing device in the above embodiments, detailed description of specific manners and functions for the modules and submodules has been made in the embodiments related to the method. Discussions above in the corresponding method embodiments apply.

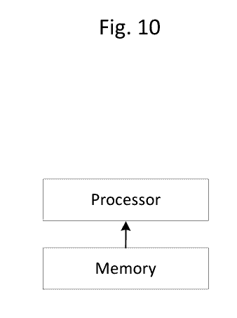

The above embodiments illustrate the internal function and structure of the photo sharing device. As shown in FIG. 10, in practice, the photo sharing device may be implemented as a processor and a memory configured to store instructions executable by the processor, wherein the instructions causes the processor to perform the methods described above.

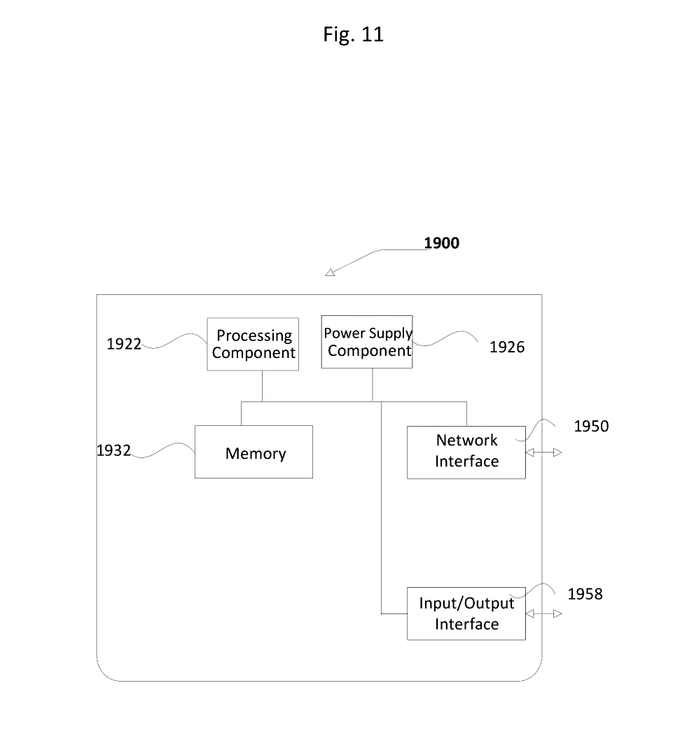

FIG. 11 illustrates a block diagram of another photo sharing device according to an exemplary embodiment. For example, the device 1900 may be provided as a server. Referring to FIG. 11, the device 1900 includes a processing component 1922 which further includes one or more processors, and memory resource represented by a memory 1932 and configured to store instructions that can be executed by the processor component 1922. The instructions stored in the memory 1932 may include one or more modules. In addition, the processor component 1922 is configured to execute instructions so as to perform the f methods described above.

The device 1900 may also include a power supply component 1926 configured to execute the power management of the device 1900, a wired or wireless network interface 1950 configured to connect the device 1900 to the network, and an input/output (I/O) interface 1958. The device 1900 can operate an operating system based on and stored in the memory 1932, for example, Windows Server™, Mac OS X™, Unix™, Linux™, FreeBSD™ or other similar operating systems.

Each module or unit discussed above for FIG. 6-9, such as the first and second receiving module, the first through fifth acquiring module, the acquiring sub-module, the first and second sending module, the determining module, the first and second determining sub-module, the first through first through fourth determining sub-module, the deleting module, the marking module, the matching module, and the storing module may take the form of a packaged functional hardware unit designed for use with other components, a portion of a program code (e.g., software or firmware) executable by the processor 1922 or the processor of FIG. 10 or the processing circuitry that usually performs a particular function of related functions, or a self-contained hardware or software component that interfaces with a larger system, for example.

The illustrations of the embodiments described herein are intended to provide a general understanding of the structure of the various embodiments. The illustrations are not intended to serve as a complete description of all of the elements and features of apparatus and systems that utilize the structures or methods described herein. Other embodiments of the disclosure will be apparent to those skilled in the art from consideration of the specification and practice of the embodiments disclosed herein. This application is intended to cover any variations, uses, or adaptations of the disclosure following the general principles thereof and including such departures from the present disclosure as come within known or customary practice in the art. It is intended that the specification and examples are considered as exemplary only, with a true scope and spirit of the invention being indicated by the following claims in addition to the disclosure.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A photo sharing method, comprising:
receiving by a cloud server an event photo sharing request sent by a terminal of an initiator of the request, wherein the event photo sharing request comprises an event marker and account identification information of an cloud account of the initiator in the cloud server;
acquiring by the cloud server, from a cloud album corresponding to the cloud account of the initiator, a first event photo set based on the event marker;
acquiring by the cloud server, according to at least one contact contained in a contact list in the cloud account of the initiator, at least one second event photo set each from a cloud album of a corresponding one of the at least one contact of the initiator, wherein each photo in the at least one second event photo set is marked with the event marker; and
sending a combined event photo set comprising the first event photo set and the at least one second event photo set to the initiator and each contact of the initiator corresponding to each of the at least one second event photo set.

2. The method of claim 1, wherein acquiring by the cloud server the at least one second event photo set comprises:
determining at least one cloud account corresponding to the at least one contact contained in the contact list in the cloud account of the initiator;
determining whether any photos marked with the event marker are present in the cloud album of the at least one contact of the initiator; and
acquiring, when at least one of the photos is marked with the event marker in the cloud album of the at least one contact, at least one second event photo set corresponding to the at least one contact of the initiator.

3. The method of claim 2, further comprising:
acquiring, via face-recognition, a first face image set of faces contained in the first event photo set and at least one second face image set of faces contained in the at least one second event photo set;
identifying a second face image set among the at least one second face image set having a weak correlation with the first face image set; and
redacting the combined event photo set by removing photos in one of the at least one second event photo set corresponding to the identified second face image set having weak correlation with the first face image set,
wherein sending the combined event photo set comprises sending the redacted combined event photo set to the initiator and each contact of the initiator corresponding to the redacted combined event photo set.

4. The method of claim 3, wherein identifying a second face image set among the at least one second face image set having a weak correlation with the first face image set comprises:
determining, for a respective second face image set among the at least one second face image set, a number of unique identical face images between the respective second face image set and the first face image set;
determining an occurrence number of identical face images between the respective second face image set and the first face image set and
identifying that the respective second face image set has weak correlation with the first face image set when the number of the identical face images is smaller than a preset number threshold and the occurrence number of identical face images is smaller than a preset occurrence number threshold.

5. The method of claim 3, the method further comprises:
obtaining at least one secondary contact list each from a cloud account belonging to a contact contained in the contact list in the cloud account of the initiator;
marking, in a combined contact list comprising the contact list of the initiator and the at least one secondary contact list, the initiator and each contact corresponding to the at least one second event photo set;
identifying via face-recognition an unmarked contact in the combined contact list having a profile picture with a face matching at least one of the faces in the first face image set and the at least one second face image set; and
sending the redacted combined event photo set to the identified unmarked contact in the combined contact list.

6. The method of claim 1, wherein the method further comprises:
receiving a storage request sent by a user terminal, wherein the storage request comprises photos marked with the event marker and a user account; and
storing the photos in a cloud album corresponding to the user account.

7. A photo sharing system, comprising:
a processor; and
a memory configured to store instructions executable by the processor;
wherein the processor is configured to cause the photo sharing system to:
receive an event photo sharing request sent by a terminal of an initiator of the request, wherein the event photo sharing request comprises an event marker and account identification information of an cloud account of the initiator in the system;
acquire, from a cloud album corresponding to the cloud account of the initiator, a first event photo set based on the event marker;
acquire, according to at least one contact contained in a contact list in the cloud account of the initiator, at least one second event photo set each from a cloud album of a corresponding one of the at least one contact of the initiator, wherein each photo in the at least one second event photo set is marked with the event marker; and
send a combined event photo set comprising the first event phot set and the at least one second event photo set to the initiator and each contact of the initiator corresponding to each of the at least one second event photo set.

8. The photo sharing system of claim 7, wherein, to acquire at least one second event photo set, the processor is configured to cause the photo sharing system to:
determine at least one cloud account corresponding to the at least one contact contained in the contact list in the cloud account of the initiator;
determine whether at least one photo marked with the event marker is present in the cloud album in the at least one cloud account corresponding to the at least one contact of the initiator; and
acquire, when at least one photo marked with the event marker is present, at least one second event photo set each corresponding to the at least one contact of the initiator.

9. The photo sharing system of claim 8, wherein the processor is further configured to cause the photo sharing system to:
acquire, via face-recognition, a first face image set of faces contained in the first event photo set and at least one second face image set of faces contained in the at least one second event photo set;
identify a second face image set among the at least one second face image set having a weak correlation with the first face image set; and
redact the combined event photo set by removing photos in one of the at least one second event photo set corresponding to the identified second face image set having weak correlation with the first face image set,
wherein to send the combined event photo set, the processor is configured to cause the photo sharing system to send the redacted combined event photo set to the initiator and each contact of the initiator corresponding to the redacted combined event photo set.

10. The photo sharing system of claim 9, wherein to identify a second face image set among the at least one second face image set having a weak correlation with the first face image set, the processor is configured to cause the photo sharing system to:
determine, for the second face image set among the at least one second face image set, a number of unique identical face images between the second face image set and the first face image set;
determine an occurrence number of identical face images between the second face image set and the first face image set; and
identify that the second face image set has weak correlation with the first face image set when the number of the identical face images is smaller than a preset number threshold and the occurrence number of identical face images is smaller than a preset occurrence number threshold.

11. The photo sharing system of claim 9, the processor is further configured to cause the photo sharing system to:
obtain at least one secondary contact list each from a cloud account belonging to a contact contained in the contact list in the cloud account of the initiator;
mark, in a combined contact list comprising the contact list of the initiator and the at least one secondary contact list, the initiator and each contact corresponding to the at least one second event photo set;
identify via face-recognition an unmarked contact in the combined contact list having a profile picture with a face matching at least one of the faces in the first face image set and the at least one second face image set; and
send the redacted combined event photo set to the identified unmarked contact.

12. The photo sharing system of claim 7, wherein the processor is further configured to cause the photo sharing system to:
receive a storage request sent by a user terminal, wherein the storage request comprises photos marked with an event marker and a user account; and
store the photos in a cloud album corresponding to the user account.

13. A non-transitory computer-readable storage medium having stored therein instructions that, when executed by a processor of a server, causes the server to:
receive an event photo sharing request sent by a terminal of an initiator of the request, wherein the event photo sharing request comprises an event marker and account identification information of an cloud account of the initiator in the server;
acquire, from a cloud album corresponding to the cloud account of the initiator, a first event photo set based on the event marker;
acquire, according to at least one contact contained in a contact list in the cloud account of the initiator, at least one second event photo set each from a cloud album of a corresponding one of the at least one contact of the initiator, wherein each photo in the at least one second event photo set is marked with the event marker; and
send a combined event photo set comprising the first event photo set and the at least one second event photo set to the initiator and each contact of the initiator corresponding to each of the at least one second event photo set.
